(19) United States
(12) Patent Application Publication
(10) Pub. No.: US 2018/0266746 A1
(43) Pub. Date: Sep. 20, 2018

(54) HEAT INSULATING CONTAINER AND METHOD FOR PRODUCING SAME

(71) Applicant: SHARP KABUSHIKI KAISHA, Sakai City, Osaka (JP)

(72) Inventors: MASAO URAYAMA, Sakai City (JP); HWISIM HWANG, Sakai City (JP); YUKA UTSUMI, Sakai City (JP); HISANORI BESSHO, Sakai City (JP); DAIJI SAWADA, Sakai City (JP); YUICHI KAMIMURA, Sakai City (JP)

(21) Appl. No.: 15/577,894

(22) PCT Filed: May 26, 2016
(86) PCT No.: PCT/JP2016/065527

§ 371 Date: May 4, 2018

(30) Foreign Application Priority Data
May 29, 2015 (JP) 2015-110613

(51) Int. Cl. F25D 3/08; B65D 81/38

(52) U.S. Cl. CPC F25D 3/08; A61J 1/165; B65D 81/3823

(57) ABSTRACT

Provided are a heat insulating container capable of maintaining a temperature of an object longer by dispersing the effect of temperature rises resulting from heat radiation, and a method for producing the same. A heat insulating container that maintains the temperature of a specific object requiring temperature control includes a first thermal storage medium, disposed to surround a center portion of the heat insulating container in which the object is placed, and a second thermal storage medium, disposed to surround the outer side of the first thermal storage medium. The first and second thermal storage media are both liquids at an intended target temperature of the object V1. The first and second thermal storage media have freezing points adjacent to and higher than a lower limit of an allowable temperature range of the object including the intended target temperature.

### TECHNICAL FIELD

The present invention relates to a heat insulating container that maintains the temperature of a specific object requiring temperature control, and to a method for producing the same.

### BACKGROUND ART

A thermal storage medium melts when having its temperature arriving at a melting point due to a phase change from the solid phase to the liquid phase while absorbing heat. A thermal storage medium solidifies, on the other hand, when having its temperature arriving at a freezing point due to a phase change from the liquid phase to the solid phase while radiating heat. A thermal storage medium with such functions is effectively used as a heat insulator that maintains a certain temperature. A heat insulating container including such a thermal storage medium as a component has been developed (see, for example, PTLs 1 to 3).

PTL 1 discloses a container that maintains a certain temperature using two types of thermal storage media. This container maintains the temperature of an object using a phase change of only one of the thermal storage media at an intended temperature. FIGS. 12A and 12B are enlarged sectional views of a container wall portion before and after the outer thermal storage medium arrives at a freezing point.

Specifically, the thermal storage media are laminated one on the other in the form of two layers to surround a thermally-insulated object. At an intended temperature, the inner thermal storage medium is in the solidified state and the outer thermal storage medium is in the melt state. When the outside temperature falls below an intended target temperature, and the temperature fall allows the temperature of the outer thermal storage medium to arrive at the freezing point, this container blocks flow in of the cold by the solidification of the outer thermal storage medium to maintain the temperature of the thermally-insulated object. This structure thus uses the phase change of only one thermal storage medium for maintaining the temperature of the object.

### CITATION LIST

### Patent Literature

PTL 1: Japanese Patent No. 5402416

PTL 2: Japanese Unexamined Patent Application Publication No. 9-68376

PTL 3: Japanese Unexamined Patent Application Publication No. 2007-118972

### SUMMARY OF INVENTION

### Technical Problem

However, a heat insulating container, such as the above container, that uses only one thermal storage medium for maintaining the temperature of an object may have an insufficient temperature maintaining function. When a heat insulating container having such a structure is to maintain the temperature of a thermally-insulated object, the heat insulating container radiates heat all at once. Thus, the heat insulating container maintains the temperature of the thermally-insulated object within an allowable range only for a short period, and may fail to maintain the temperature of the thermally-insulated object within a specific range for a long period.

FIGS. 13A and 13B are enlarged sectional views of a wall portion of a heat insulating container before and after a thermal storage medium arrives at a freezing point. At the time point when the heat insulating container is exposed to a cold outside atmosphere, the thermal storage medium is in the melt state, as illustrated in FIG. 13A. As the temperature inside the heat insulating container gradually decreases toward the outside temperature, the outer thermal storage medium solidifies. As illustrated in FIG. 13B, the thermal storage medium radiates heat all at once due to the phase change of its solidification.

For example, during transportation of a vaccine under controlled temperatures, the temperature of the vaccine needs to be controlled for a predetermined period within a narrow allowable range of 2 to 8° C. If the thermally-insulated object has its temperature fall below the allowable range as the heat radiation fails to continue for a fully long time at the time of solidification of the thermal storage medium, the vaccine would impair its intrinsic function.

The present invention is made in view of the above circumstances, and aims to provide a heat insulating container that can maintain the temperature of an object for a longer time by dispersing the effect of temperature rises resulting from heat radiation, and a method for producing the same.

### Solution to Problem

In order to achieve the above object, a heat insulating container according to the present invention is a heat insulating container that maintains the temperature of a specific object requiring temperature control. The heat insulating container includes a first thermal storage medium, disposed to surround a center portion of the heat insulating container in which the object is placed, and a second thermal storage medium, disposed to surround the outer side of the first thermal storage medium. The first and second thermal storage media are both liquids at an intended target temperature of the object. The first and second thermal storage media have freezing points adjacent to and higher than a lower limit of an allowable temperature range of the object including the intended target temperature.

The two thermal storage media disposed as separate layers that surround an object cause, sequentially from the outer thermal storage medium, the phase change of solidification to radiate heat. This structure can thus extend time for which the temperature of the object is maintained by dispersing the effect of temperature rises resulting from the heat radiation.

### Advantageous Effects of Invention

The present invention can maintain the temperature of an object for a longer time by dispersing the effect of temperature rises resulting from heat radiation.

### BRIEF DESCRIPTION OF DRAWINGS

FIG. 1 is a sectional view of a heat insulating container according to a first embodiment when viewed in a plan.

FIG. 2 is an enlarged sectional view of a wall portion of the heat insulating container according to the first embodiment at an intended target temperature when viewed from a side.

FIG. 3 is a graph of the temperature changes of double-layer thermal storage media and a single-layer thermal storage medium.

FIG. 4 is a graph of the temperature changes of the double-layer thermal storage media.

FIG. 5 is an enlarged sectional view of a wall portion of the heat insulating container including thermal storage media that have different concentrations and different weights at an intended target temperature when viewed from a side.

FIG. 6A is a graph of the temperature changes of the double-layer thermal storage media that have different concentrations and different weights.

FIG. 6B is a graph of the temperature changes of the double-layer thermal storage media that have different concentrations and different weights.

FIG. 7 is a sectional view of a heat insulating container according to a second embodiment when viewed in a plan.

FIG. 8 is a graph of the temperature changes of an object inside heat insulating containers not including and including a heat conducting member.

FIG. 9 is a sectional view of a heat insulating container according to a third embodiment when viewed in a plan.

FIG. 10 is a graph of the temperature changes of an object inside heat insulating containers not including and including a heat insulating member.

FIG. 11 is a sectional view of a heat insulating container according to a fourth embodiment when viewed in a plan.

FIG. 12A is an enlarged sectional view of a wall portion of the heat insulating container when viewed from a side, before the outer thermal storage medium arrives at the freezing point.

FIG. 12B is an enlarged sectional view of a wall portion of the heat insulating container when viewed from a side, after the outer thermal storage medium arrives at the freezing point.

FIG. 13A is an enlarged sectional view of a wall portion of the heat insulating container when viewed from a side, before the thermal storage medium arrives at the freezing point.

FIG. 13B is an enlarged sectional view of a wall portion of the heat insulating container when viewed from a side, after the thermal storage medium arrives at the freezing point.

### DESCRIPTION OF EMBODIMENTS

Embodiments of the present invention are described with reference to the drawings.

### First Embodiment

### Structure of Heat Insulating Container

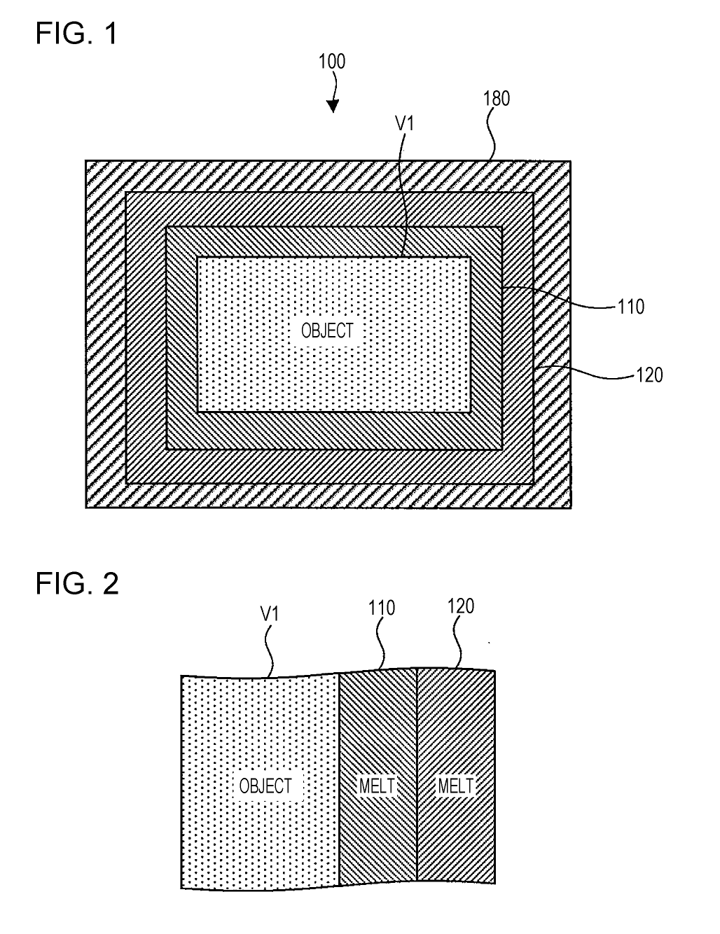

FIG. 1 is a sectional view of a heat insulating container 100 when viewed in a plan. The heat insulating container 100 is used to maintain the temperature of a specific object V1 requiring temperature control. The heat insulating container 100 includes a thermal storage medium 110 (first thermal storage medium), a thermal storage medium 120 (second thermal storage medium), and an exterior wall 180. The thermal storage media 110 and 120 are kept in sealed resin bags, such as nylon bags, and formed in layers of thermal storage packages. In the following description of thermal storage media serving as components of a heat insulating container, the thermal storage media similarly correspond to ones kept in sealed thermal storage packages.

The thermal storage medium 110 is disposed to surround a center portion, in which the object V1 is placed. The thermal storage medium 120 is disposed in contact with the thermal storage medium 110 and to surround the outer side of the thermal storage medium 110. Preferably, the thermal storage media 110 and 120 uniformly surround the inside from every direction.

The thermal storage media 110 and 120 may be formed of, for example, the same material, but are preferably formed of different materials. Different materials may be formed from the same raw material with different concentrations. Specifically, a material containing TBAB as a guest and water as a host can be used, and can have its solidification start temperature changed by concentration adjustment. Examples of guest materials of the thermal storage medium that can have its solidification start temperature changed with its concentration adjustment include, beside TBAB, quaternary ammonium salts such as TBAC. In addition, examples usable as a thermal storage medium include NaCl, NH4Cl, KCl, KHCO3, THF, cyclohexane, n-pentyl ammonium bromide, and TBAF.

FIG. 2 is an enlarged sectional view of a wall portion of the heat insulating container 100 at an intended target temperature when viewed from a side. The thermal storage media 110 and 120 are both liquids or melt at the intended target temperature of the object V1. The thermal storage media 110 and 120 have freezing points closer to and higher than the lower limit of an allowable temperature range of the object V1, including the intended target temperature.

The two thermal storage media 110 and 120 disposed as separate layers that surround the object V1 cause, sequentially from the outer thermal storage medium 120, the phase change of solidification to radiate heat. The heat insulating container can maintain the temperature of an object for a longer time by dispersing the effect of temperature rises resulting from heat radiation. The structure including two or more layers of thermal storage media is also effective in further restricting the temperature rises of the object V1 resulting from heat radiation than in the structure including a single layer of a thermal storage medium.

Preferably, the thermal storage media 110 and 120 are in a layer form and disposed parallel to an isothermal surface at a time when heat flows in from the outside. Specifically, in a rectangular parallelepiped container, the layers are disposed to have their surfaces parallel to the wall surfaces. Such disposition allows the respective thermal storage media to start solidifying at different times to maintain the temperature of the object V1 for a longer time and restrict the level of the temperature rises resulting from heat radiation.

This structure facilitates solidification from the outer thermal storage medium 120. Specifically, the thermal storage medium 120 starts solidifying first, and the heat radiation resulting from the solidification prevents solidification of the thermal storage medium 110. Specifically, the thermal storage medium 110 has its temperature raised and does not start solidifying until the thermal storage medium 120 finishes radiating heat. After the thermal storage medium 120 finishes solidifying and radiating heat, the temperature of the thermal storage medium 110 falls and arrives at the solidification start temperature. Then, the thermal storage medium 110 starts solidifying. This structure allows the respective thermal storage media to start solidifying at different times to maintain the temperature of the object V1 for a longer time and restrict the temperature rises resulting from heat radiation.

Preferably, the freezing point of the thermal storage medium 120 is higher than the freezing point of the thermal storage medium 110. Specifically, freezing points Ta and Tb of the respective thermal storage media 110 and 120 are preferably determined to satisfy Ta<Tb. When the outside temperature is lower than the intended target temperature, such a structure is more likely to allow the cold to flow in to start solidification from the outer thermal storage medium 120. The same change occurs also in the structure where the solidification start temperatures are determined to be Ta=Tb, since the outer thermal storage medium 120, from which the cold flows in, starts solidifying first, and heat radiation resulting from the solidification prevents the thermal storage medium 110 from solidifying. To secure design allowance, however, the solidification start temperatures preferably satisfy Ta<Tb.

### Application of Heat Insulating Container

The heat insulating container 100 has its allowable temperature range determined in accordance of its purpose of use. Preferably, the heat insulating container 100 has, particularly, the lower limit of the allowable temperature range determined within the range of 1 to 3° C. This structure enables transportation of an object V1 having its lower limit temperature around 2° C., such as some vaccines or other medical supplies, under constant temperatures without the need of power for a predetermined period.

Preferably, the heat insulating container 100 includes an exterior wall 180 formed of a heat insulating member to be used for transportation for cold areas. During transportation of an object V1 for, particularly, cold areas, the thermal storage media 110 and 120 solidify around the lower limit of the allowable temperature range and radiate heat, to prevent the object V1 from being cooled further below the lower limit of the allowable temperature range. For example, some vaccines are prevented from losing their functions due to solidification.

Examples of an inactivated vaccine of the above some vaccines include a recombinant precipitated divalent human papilloma virus-like particle vaccine, a recombinant precipitated quadrivalent human papilloma virus-like particle vaccine, an inactivated polio vaccine (Salk vaccine), a dried haemophilus type-b vaccine, a precipitated 13-valent pneumococcal conjugate vaccine, and a quadrivalent meningococcal vaccine (diphtheria toxoid conjugate). Examples of a live vaccine of the above some vaccines include an oral live attenuated human rotavirus vaccine, and a pentavalent oral live attenuated rotavirus vaccine.

Other example of the object V1 include perishable foods. Perishable foods respectively have their suitable storage temperatures. With respect to vegetables, for example, the suitable storage temperature for cucumbers ranges from 10 to 12° C., that for cabbages is 0° C., and that for tomatoes (fully ripened) ranges from 8 to 10° C. With respect to fruits, the suitable storage temperature for netted melons ranges from 2 to 5° C., and that for bananas (yellow ripened) ranges from 13 to 16° C. Particularly, the optimum temperature for storing yellow ripened bananas is around 15° C. (that for green ripened bananas is around 13.5° C.). Bananas may fail to be smoothly ripened if even temporarily placed under the temperature of lower than or equal to 13° C., or may have its peel discolored due to chilling injury. Bananas thus require a strict temperature control.

### Method for Producing Heat Insulating Container

A method for producing the heat insulating container 100 having the above structure is described. First, a container body having the exterior wall 180 formed of a heat insulating member is prepared. Then, at least two layers of thermal storage media (thermal storage media 110 and 120) having freezing points adjacent to and higher than the lower limit of an allowable temperature range of the object V1, including the intended target temperature, are prepared.

The prepared layers of the thermal storage media having their temperatures adjusted to the intended target temperature are disposed on the inner side of the exterior wall 180 to form the heat insulating container 100. Here, the thermal storage media 110 and 120 are liquids, and the layers are laminated by disposing thermal storage packages. The object V1 is placed on the inner side of the innermost thermal storage medium 110. This structure restricts the temperature rises of the object V1 resulting from the heat radiation, and can extend the time for maintaining the temperature by dispersing the effect of the temperature change.

### Verification (1) of Effect of Double-Layer Structure

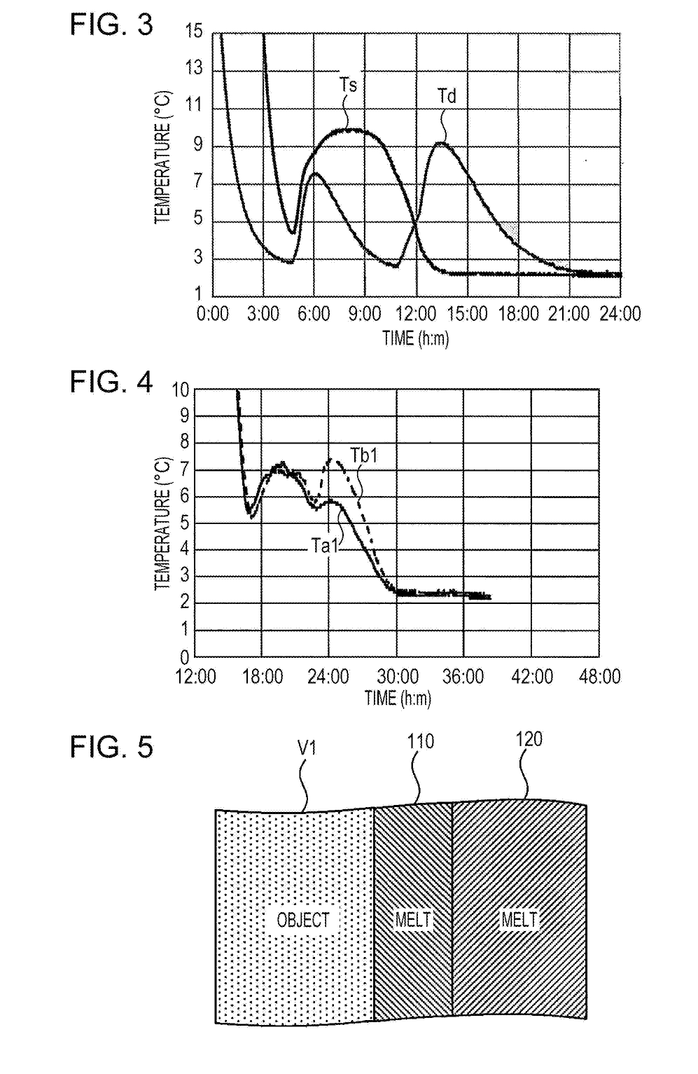

The temperature changes were measured between different thermal storage medium structures to verify that the heat insulating container 100 is more efficient than an existing container. FIG. 3 is a graph of the temperature changes of double-layer thermal storage media and a single-layer thermal storage medium.

A temperature change Td represents the temperature change resulting from cooling, from one side, a stack of a thermal storage medium (TBAB at a concentration of 40 wt % with a weight of 25 g) and a thermal storage medium (TBAB at a concentration of 30 wt % with a weight of 25 g). A temperature change Ts represents the temperature change resulting from cooling only one thermal storage medium (TBAB at a concentration of 40 wt % with a weight of 50 g). The double-layer thermal storage media have freezing points made different through concentration adjustments.

Specifically, the temperature changes Td and Ts are equivalent to the temperature changes of the object V1 in the heat insulating containers 100 containing the same amount of thermal storage media, while one of which has double-layer thermal storage media and the other has a single-layer thermal storage medium, measured when both heat insulating containers 100 are cooled from the outside under the same conditions.

The temperature change Ts of the single-layer thermal storage medium shows one large peak due to the heat radiated from a phase change. The temperature change Ts shows, following the peak, a rapid cooling of the object V1. On the other hand, the temperature change Td of the double-layer thermal storage media shows two separate peaks. The temperature change Td shows a first peak resulting from the heat radiation after solidification of the outer thermal storage medium, and then shows a second peak resulting from the heat radiation after solidification of the inner thermal storage medium. Both peaks in the temperature change Td are lower than and continue about 1.5 times longer than the peak shown in the temperature change Ts. The above results reveal that the constant temperature has been maintained for a longer period and the temperature rises due to heat radiation is restricted in the container having the two-layer structure.

Verification (2) of Effect of Double-Layer Structure

The temperature changes of the heat insulating container 100 including a double-layer thermal storage media having the same freezing point and the same weight were measured. Specifically, the temperature changes of thermal storage media resulting from cooling, from one (outer) side, a stack of an inner thermal storage medium 110 (TBAB at a concentration of 40 wt % with a weight of 25 g) and an outer thermal storage medium 120 (TBAB at a concentration of 40 wt % with a weight of 25 g) were measured. FIG. 4 is a graph of the temperature changes of the double-layer thermal storage media. A temperature change Ta1 represents the temperature change of the thermal storage medium 110 opposite to (on the inner side of) the cooled side. The temperature change Tb1 represents the temperature change of the thermal storage medium 120 on the cooled (outer) side. As illustrated in FIG. 4, cold air solidifies the outer thermal storage medium 120 first and then solidifies the thermal storage medium 110.

### Verification (3) of Effect of Double-Layer Structure

However, after experiments similar to the above are repeated, the sequence of the solidification start times of the thermal storage media 110 and 120 may be disturbed, and the thermal storage medium 110 may start solidifying before the thermal storage medium 120 finishes solidifying. In that case, the thermal storage media 110 and 120 made of the materials having the same freezing point do not have the difference between their solidification start temperatures. On the other hand, the following method of using thermal storage media having different weights is available to fully reproduce the temperature maintenance resulting from the difference between the solidification start times and the sequential solidifications.

The temperature changes of the heat insulating container 100 having a double-layer structure including the thermal storage media 110 and 120, which have different freezing points and different weights, were measured. Specifically, the temperature changes of the thermal storage media 110 and 120 resulting from cooling, from one (outer) side, a stack of the thermal storage medium 110 (TBAB at a concentration of 40 wt % with a weight of 25 g) and the thermal storage medium 120 (TBAB at a concentration of 35 wt % with a weight of 50 g) were measured. In this case, the thermal storage medium 110 has a freezing point higher than the freezing point of the thermal storage medium 120.

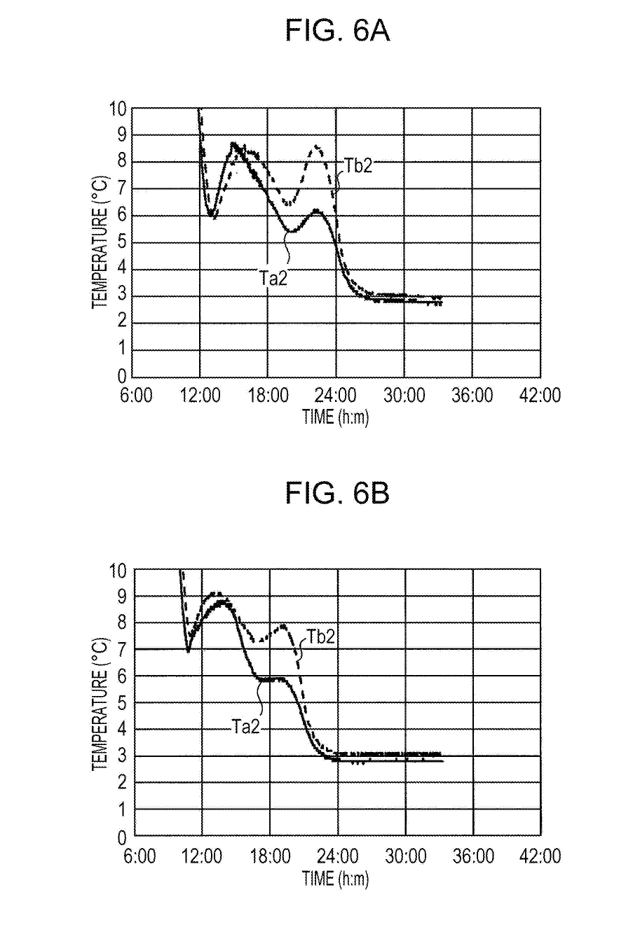

FIG. 5 is an enlarged sectional view of a wall portion of the heat insulating container 100 including the thermal storage media 110 and 120 that have different concentrations and different weights at an intended target temperature when viewed from a side. FIGS. 6A and 6B are graphs of the temperature changes Ta2 and Tb2 of the respective double-layer thermal storage media 110 and 120 that have different concentrations and different weights. FIGS. 6A and 6B are respectively the graphs for a first solidification experiment and for a second solidification experiment.

As illustrated in FIGS. 6A and 6B, the medium having a larger weight even with a lower freezing point solidifies first in both experiments. These experiments verify that the thermal storage media 110 and 120 having the same concentration can more securely solidify in sequence by having different weights. This is probably because the media having the same concentration have the same nucleation probability, and the medium having a larger amount has a larger number of nuclei and solidifies first.

In consideration of the above verification results, in the heat insulating container 100, the outer thermal storage medium 120 preferably has a weight larger than the weight of the inner thermal storage medium 110. This structure can securely solidify the outer thermal storage medium 120 first. Even if heat unevenly flows into the container (heat is unevenly insulated), the thermal storage media 110 and 120 having different weights are more likely to solidify in sequence than in the case where the thermal storage media 110 and 120 have the same weight.

### Second Embodiment

### Structure of Heat Insulating Container

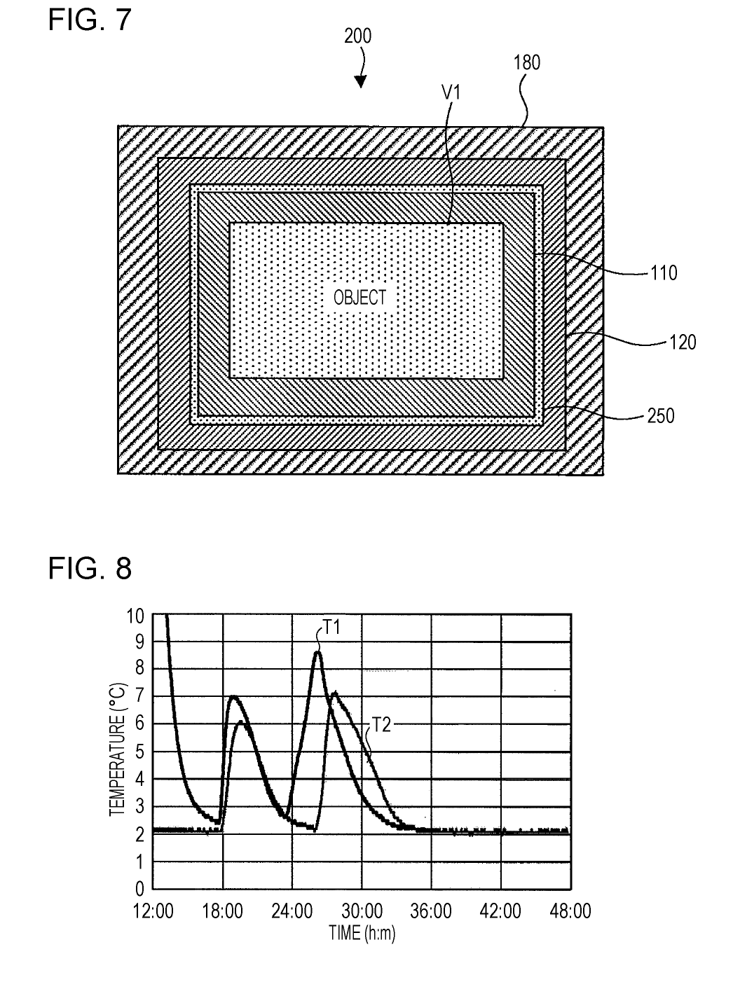

In the above embodiment, the thermal storage medium 120 is disposed in contact with and on the outer side of the thermal storage medium 110. However, a heat conducting member 250 may be interposed between the thermal storage medium 110 and the thermal storage medium 120. FIG. 7 is a sectional view of a heat insulating container 200 including the heat conducting member 250 when viewed in a plan.

As illustrated in FIG. 7, the heat insulating container 200 includes a heat conducting member 250 between the thermal storage medium 110 and the thermal storage medium 120 and has the same structure as the heat insulating container 100 except for this point. The heat conducting member 250 is made of a material having higher thermal conductivity than at least the thermal storage media 110 and 120. In view of availability and handleability, for example, an aluminum tape is preferably usable as the heat conducting member 250.

The heat conducting member 250 interposed between the thermal storage media 110 and 120 facilitates heat conduction between the thermal storage media 110 and 120, and restricts the temperature rise of the object V1 and can manage the upper limit temperature of a low allowable temperature range.

### Verification of Effect of Heat Conducting Member

The temperature changes of the object V1 in the two heat insulating containers 100 and 200 that differ in terms of whether the heat conducting member 250 is included were compared. FIG. 8 is a graph of the temperature changes T1 and T2 of the object in the respective heat insulating containers 100 and 200, not including and including the heat conducting member 250. An aluminum tape was used as an example of the heat conducting member 250. A TBAB-tetraboric acid 2% aqueous solution was used as each of the thermal storage media 110 and 120.

As illustrated in FIG. 8, the temperature change T1 of the object V1 in the heat insulating container 100 shows an upper limit temperature of 8.5° C., resulting from the solidification of the thermal storage medium 110. On the other hand, the temperature change T2 of the object V1 in the heat insulating container 200 shows an upper limit temperature of 7° C., which is kept lower by reducing the temperature rise due to the heat radiation at the solidification.

### Third Embodiment

### Structure of Heat Insulating Container

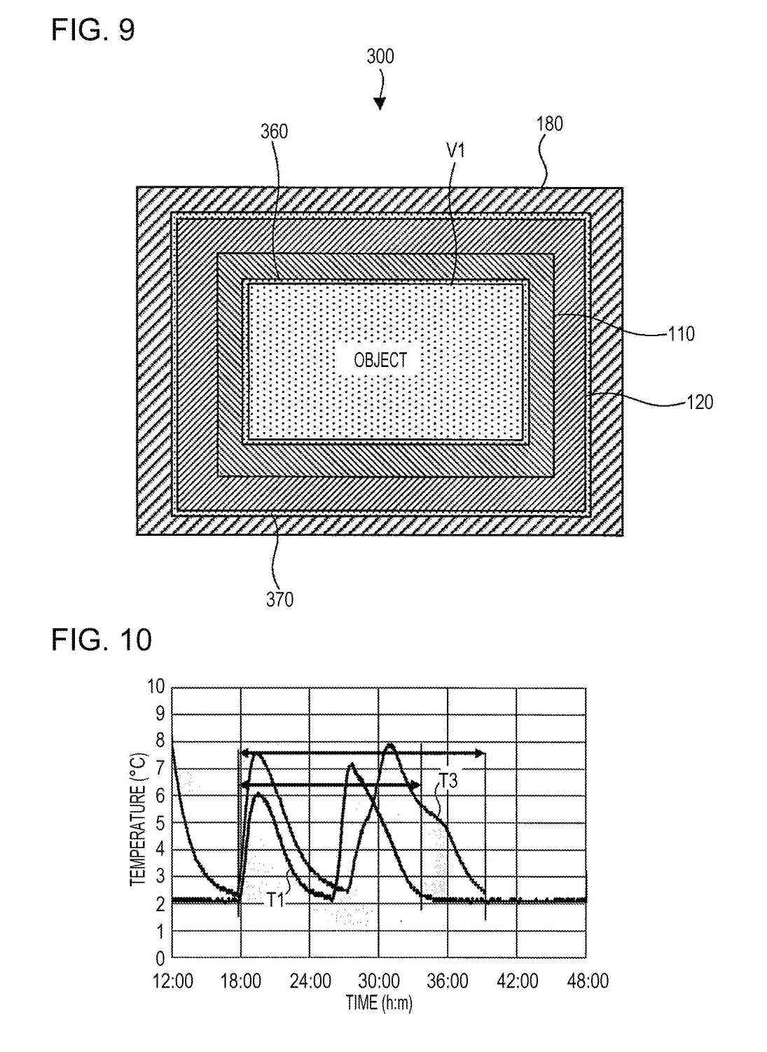

In the above embodiment, the heat insulating container 100 does not include a heat insulating member, but may include a heat insulating member. FIG. 9 is a sectional view of a heat insulating container 300 including a heat insulating member when viewed in a plan. As illustrated in FIG. 9, the heat insulating container 300 includes a heat insulating member 360 between the object V1 and the thermal storage medium 110, and a heat insulating member 370 on the outer side of the outermost thermal storage medium 120. The heat insulating container 300 has the same structure as the heat insulating container 100 except for these points. The heat insulating members 360 and 370 surrounding the object in this manner confine the heat radiated during the solidification between the thermal storage media 110 and 120 and can maintain the temperature of the object for a longer period. For example, a styrene foam may be used as each of the heat insulating members 360 and 370.

### Verification of Effect of Heat Insulating Members

The temperature changes of the object V1 in the two heat insulating containers 100 and 300 that differ in terms of whether the heat insulating members 360 and 370 are included were compared. FIG. 10 is a graph of the temperature changes T1 and T3 of the object in the respective heat insulating containers 100 and 300, not including and including the heat insulating members 360 and 370. A styrene foam was used as each of the heat insulating members 360 and 370. A TBAB-tetraboric acid 2% aqueous solution was used as each of the thermal storage media 110 and 120.

As illustrated in FIG. 10, the temperature change T1 of the object V1 in the heat insulating container 100 shows that the temperature of the object V1 was maintained for 16 hours with the heat radiation of the thermal storage media 110 and 120. On the other hand, the temperature change T3 of the object V1 in the heat insulating container 300 shows that the temperature of the object V1 was maintained for 21 hours with the heat radiation of the thermal storage media 110 and 120 and the heat confined by the heat insulating members 360 and 370.

### Fourth Embodiment

### Structure of Heat Insulating Container

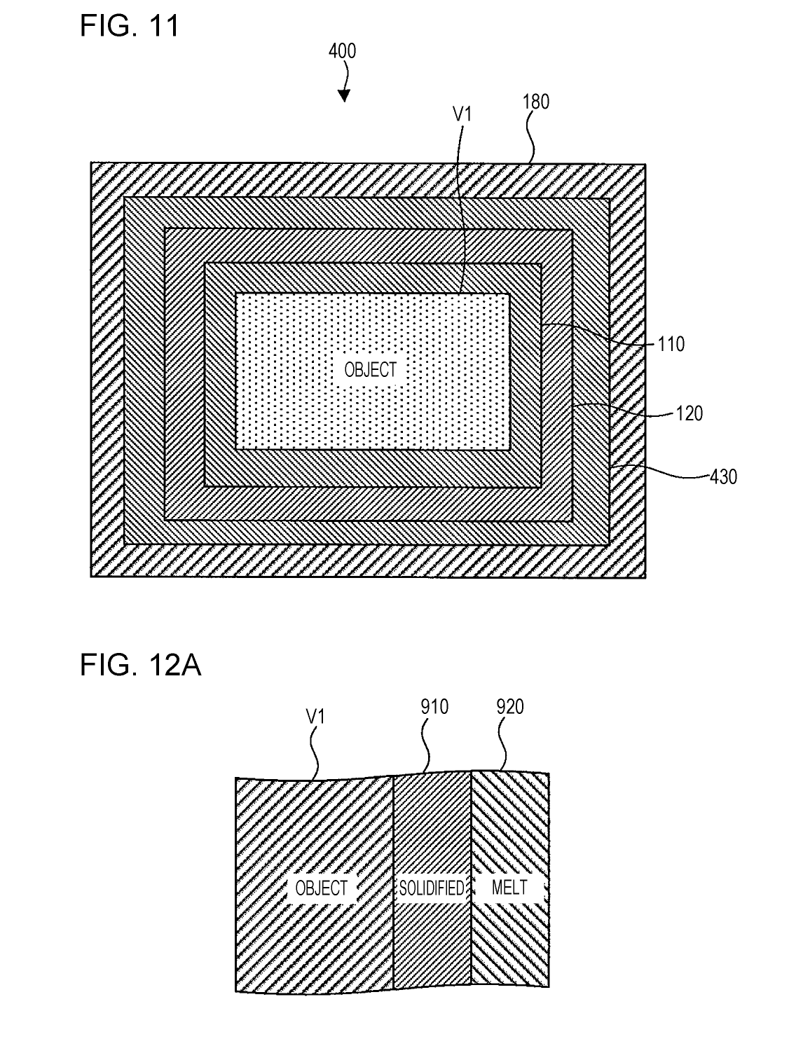

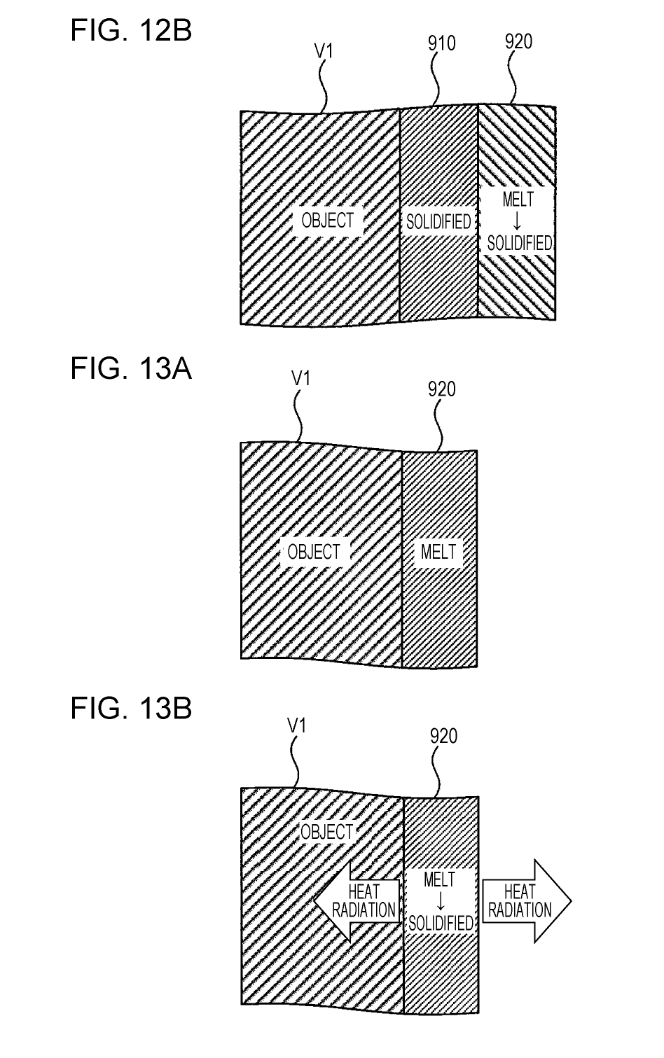

In the above embodiment, the heat insulating container 100 includes two layers of thermal storage media 110 and 120, but may include three or more layers of thermal storage media. FIG. 11 is a sectional view of a heat insulating container 400 including three layers of thermal storage media when viewed in a plan. The heat insulating container 400 includes a thermal storage medium 430, which surrounds the outer sides of the thermal storage media 110 and 120. The heat insulating container 400 has the same structure as the heat insulating container 100 except for these points. Specifically, the heat insulating container 400 includes the thermal storage medium 430 between the thermal storage medium 120 and an exterior wall 180.

This structure prevents the outside temperature from directly affecting the inner thermal storage media 110 and 120 with a buffering function of the thermal storage medium 430, which is located outermost of all the multiple thermal storage media, and can maintain the constant temperature regardless of the outside temperature. This structure can highly effectively maintain the temperature of the object regardless of the outside temperature. The thermal storage medium 430 may have a freezing point the same as the freezing points of the thermal storage media 110 and 120.

### Application Example of Heat Insulation Container

When the heat insulating container 400 is used, the thermal storage media 110 and 120 having the freezing points determined around the lower limit of the intended allowable temperature range are disposed in the container at the temperature equivalent to the intended target temperature. The temperature of the thermal storage medium 430 is set lower than the freezing points of the thermal storage media 110 and 120, and the thermal storage medium 430 is set in a solid phase.

Then, the thermal storage media 120 and 110 cooled by the thermal storage medium 430 sequentially cause phase changes from the melt state to the solidified state. During the phase changes, the object is prevented from falling below the freezing point. Each temperature rise resulting from the heat radiation at the solidification is restricted by the other two layers of the thermal storage media, so that the upper limit temperature is kept low. In addition, the temperature range between the lower limit and the upper limit can be reduced, so that the temperature can be maintained more accurately.

This structure prevents the outside temperature from affecting the thermal storage media 110 and 120 with the buffering function of the outermost thermal storage medium 430, and can maintain the constant temperature regardless of the outside temperature, although the outside temperature is higher than the upper limit of the intended temperature range until the thermal storage medium 430 melts. Specifically, the thermal storage medium 430 enables maintaining the temperature of a thermally-insulated object regardless of the outside temperature.

### Verification of Effect of Triple-Layer Structure

Experiments were conducted under the same conditions by cooling, from one side, a single-layer thermal storage medium and triple-layer thermal storage media, each made of the same material and having the same amount in total. The single-layer structure maintained the temperature range of 2 to 10° C. for ten hours, whereas the triple layer structure maintained the temperature range of 2 to 9° C. for 20 hours. The experiments verified that the triple-layer thermal storage media highly effectively maintain the temperature.

This international application claims benefit of priority from Japanese Patent Application No. 2015-110613 filed on May 29, 2015. The entire contents of Japanese Patent Application No. 2015-110613 are hereby incorporated by reference.

### REFERENCE SIGNS LIST

100 heat insulating container
110, 120 thermal storage medium
180 exterior wall
200 heat insulating container
250 heat conducting member
300 heat insulating container
360, 370 heat insulating member
400 heat insulating container
430 thermal storage medium
T1, T2, T3, Td, Ts, Ta1, Ta2, Tb1, Tb2 temperature change
V1 object

1. A heat insulating container that maintains a temperature of a specific object requiring temperature control, the container comprising:
a first thermal storage medium disposed to surround a center portion of the heat insulating container in which the object is placed; and
a second thermal storage medium disposed to surround an outer side of the first thermal storage medium,
wherein the first thermal storage medium and the second thermal storage medium are both liquids at an intended target temperature of the object, and have freezing points adjacent to and higher than a lower limit of an allowable temperature range of the object including the intended target temperature,
wherein the second thermal storage medium has its temperature raised by the heat radiation resulting from the solidification.

2. A heat insulating container that maintains a temperature of a specific object requiring temperature control, the container comprising:
a first thermal storage medium disposed to surround a center portion of the heat insulating container in which the object is placed,
a second thermal storage medium disposed to surround an outer side of the first thermal storage medium; and
a heat conducting member interposed between the first thermal storage medium and the second thermal storage medium,
wherein the first thermal storage medium and the second thermal storage medium are both liquids at an intended target temperature of the object, and have freezing points adjacent to and higher than a lower limit of an allowable temperature range of the object including the intended target temperature.

3. The heat insulating container according to claim 1, wherein the first thermal storage medium and the second thermal storage medium are in a layer form and disposed parallel to an isothermal surface at a time when heat flows in from an outside.

4. The heat insulating container according to claim 1, wherein the freezing point of the second thermal storage medium is higher than the freezing point of the first thermal storage medium.

5. The heat insulating container according to claim 1, wherein the second thermal storage medium has a weight larger than a weight of the first thermal storage medium.

6. The heat insulating container according to claim 1, further comprising a heat conducting member interposed between the first thermal storage medium and the second thermal storage medium.

7. The heat insulating container according to claim 1, further comprising a heat insulating member interposed between the object and the thermal storage media or disposed on an outer side of an outermost one of the thermal storage media.

8. The heat insulating container according to claim 1, further comprising a thermal storage medium disposed to surround an outer side of the second thermal storage medium.

9. The heat insulating container according to claim 1, wherein the lower limit of the allowable temperature range is within 1 to 3° C.

10. The heat insulating container according to claim 1, wherein the heat insulating container includes an exterior wall made of a heat insulating member to be used for transportation to a cold area.

11. A method for producing a heat insulating container that maintains a temperature of a specific object requiring temperature control, the method comprising:
a step of preparing a container body including an exterior wall made of a heat insulating member;
a step of preparing at least two layers of a thermal storage medium having a freezing point adjacent to and higher than a lower limit of an allowable temperature range of the object including an intended target temperature;
a step of disposing the at least two layers of the thermal storage medium on an inner side of the exterior wall, with the thermal storage medium having a temperature adjusted to the intended target temperature; and
a step of placing the object on an innermost side of the thermal storage medium,
wherein at least an outermost one of the thermal storage media has its temperature raised by the heat radiation resulting from the solidification.
